(19) United States
(12) Patent Application Publication
(10) Pub. No.: US 2004/0122824 A1
(43) Pub. Date: Jun. 24, 2004

(54) Apparatus and method for market-based document content selection

(76) Inventor: Scott H. Clearwater, Portola Valley, CA (US)

Correspondence Address: HEWLETT-PACKARD COMPANY, Intellectual Property Administration, P.O. Box 272400, Fort Collins, CO, 80527-2400, US

(21) Appl. No.: 10/326,088

(22) Filed: Dec. 23, 2002

(51) Int. Cl. G06F 7/00

(52) U.S. Cl. 707/100

(57) ABSTRACT

A method and corresponding apparatus for market-based document content selection use an automated auction or bartering system, i.e., an automated content selection system, to automatically select content for document presentation. The system takes simple criteria from a user and automatically constructs virtual documents from a much larger underlying database of content. By trading among the virtual documents, the automated content selection system affords a flexible and scalable method for selecting high-value content. The trading among the virtual documents can be adjusted to accommodate particularly complicated user preferences in order to improve content search efficiency. Additional criteria for incorporating user preferences is easy to accomplish. Therefore, users are shown relevant content in a usable form to help with decision making process.

### CROSS-REFERENCE TO RELATED PATENT APPLICATIONS

This application is related to commonly assigned U.S. patent application Ser. No. 10/ ______ (Attorney Docket No. 100202496-1), entitled “APPARATUS AND METHOD FOR MARKET-BASED DOCUMENT CONTENT AND LAYOUT SELECTION” to Scott H. CLEARWATER; U.S. patent application Ser. No. 10/ ______ (Attorney Docket No. 10019008-1), entitled “APPARATUS AND METHOD FOR DOCUMENT CONTENT TRADING” to Scott H. CLEARWATER, et al.; U.S. patent application Ser. No. 10/ ______ (Attorney Docket No. 10018740-1), entitled “APPARATUS AND METHOD FOR CONTENT RISK MANAGEMENT” to Scott H. CLEARWATER; U.S. patent application Ser. No. 10/ ______ (Attorney Docket No. 100110399-1), entitled “APPARATUS AND METHOD FOR MARKET-BASED GRAPHICAL GROUPING” to Henry W. SANG, Jr., et al., and U.S. patent application Ser. No. 10/ ______ (Attorney Docket No. 10019320-1), entitled “APPARATUS AND METHOD FOR MARKET-BASED DOCUMENT LAYOUT SELECTION” to Henry W. SANG, Jr., et al., all of which are concurrently herewith being filed under separate covers, the subject matters of which are herein incorporated by reference.

### TECHNICAL FIELD

The technical field relates to document selection systems, and, in particular, to market-based document content selection systems.

### BACKGROUND

Content selection is important to document composition. In constructing a document, such as catalog or advertisement, users typically select document elements from a large corpus of possible items, or a number of possible combinations of various items. Without the time or ability to articulate what is intended, users usually need help in selecting such document elements. Therefore, being able to automatically include document elements on pages is important in creating a high-value document. However, automated selection of document elements is especially difficult because of the lack of semantic data related to the document elements.

Some current solutions focus on complicated rule sets that are difficult to maintain and understand. For example, since many circumstances cannot be known in advance, a rule-based approach may easily cause error when unanticipated situations occur. Furthermore, while contingencies can in principle be codified, the resulting system is not easily maintainable because the rules can interact with each other in complicated and unforeseen ways.

Other document management systems automatically lay out content or advertisement pages, but do not address content selection. Some other systems are based on explicit selections and involve no coordination among cooperating entities to produce a high-value document. Still other systems deal with rule-based retrieval without information on how the retrieval content will interact among its components.

### SUMMARY

A method for market-based document content selection includes selecting a plurality of contents from a database, constructing a plurality of virtual documents using the plurality of selected contents, evaluating the plurality of selected contents with respect to user preferences, and calculating values of the plurality of virtual documents based on the evaluation. If the value of the corresponding virtual document increases, a trade is consummated from an old content to one of the plurality of selected contents. After a stopping criterion is met, a layout specification with preferred contents is generated from the plurality of selected contents for document rendering.

A corresponding apparatus for market-based document content selection includes a system configuration input for setting configuration parameters for a content selection algorithm, a user preference input for setting user preferences for the content selection algorithm, and an automated content selection system capable of using the content selection algorithm to automatically select contents based on the user preferences. The automated content selection system includes a content broker for supervising and coordinating the content selection.

### DESCRIPTION OF THE DRAWINGS

The preferred embodiments of the method and apparatus for market-based document content selection will be described in detail with reference to the following figures, in which like numerals refer to like elements, and wherein:

FIG. 1 illustrates an exemplary document with pages that include various objects;

FIG. 2 illustrates an exemplary automated content selection system, according to one embodiment of the present invention;

FIG. 3A is a flow chart illustrating an exemplary operation of a content broker, according to another embodiment of the present invention;

FIG. 3B illustrates an exemplary evaluation process of FIG. 3A, according to another embodiment of the present invention; and

FIG. 4 illustrates exemplary hardware components that may be used in connection with the method for market-based document content selection, according to another embodiment of the present invention.

### DETAILED DESCRIPTION

A method and corresponding apparatus for market-based document content selection use an automated auction or bartering system, i.e., an automated content selection system, to automatically select content for document presentation. The system takes criteria from a user and automatically constructs virtual documents from a much larger underlying database of content. By trading among the virtual documents, the automated content selection system affords a flexible and scalable method for selecting high-value content. The trading among the virtual documents can be adjusted to accommodate user preferences in order to improve content search efficiency. Additional criteria for incorporating user preferences is easy to accomplish. Therefore, users are shown relevant content in a usable form to help with decision making process.

With the market-based document layout selection approach, document elements compete with each other in a “market” where a page tries to “buy” a content item that the page deems valuable. The value of a particular page is based on a number of factors relating to user preferences, such as price or style. The advantage of a market-based approach is that the market-based approach does not require a fixed set of rules that must be able to handle all possible contingencies.

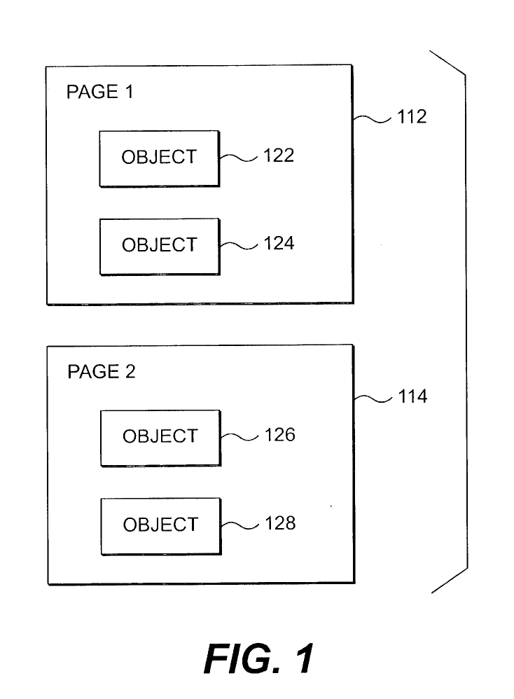

In document construction, different objects are placed on pages. An object refers to any item that can be individually selected and manipulated, and may include shapes and pictures that appear on a display screen. An object may include both data and programmed procedures that allow manipulation of that data. Examples of the objects include images, tables, columns of information, boxes of data, graphs of data, audio snippets for electronic versions of assignments, active pages such as an applet for electronic version, animations or the like. The images may be drawings or photographs in color or black and white. An active page is a page that changes layout when a user modifies an object on the page. FIG. 1 illustrates an exemplary document with Page 1 112, Page 2 114. Page 1 112 includes objects 122, 124, whereas Page 2 114 includes objects 126, 128.

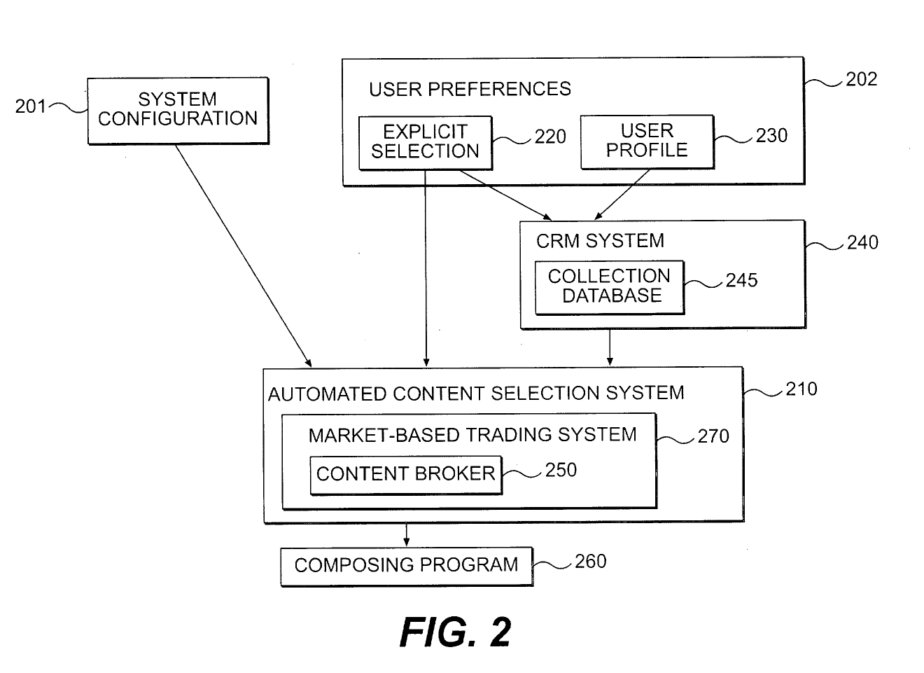

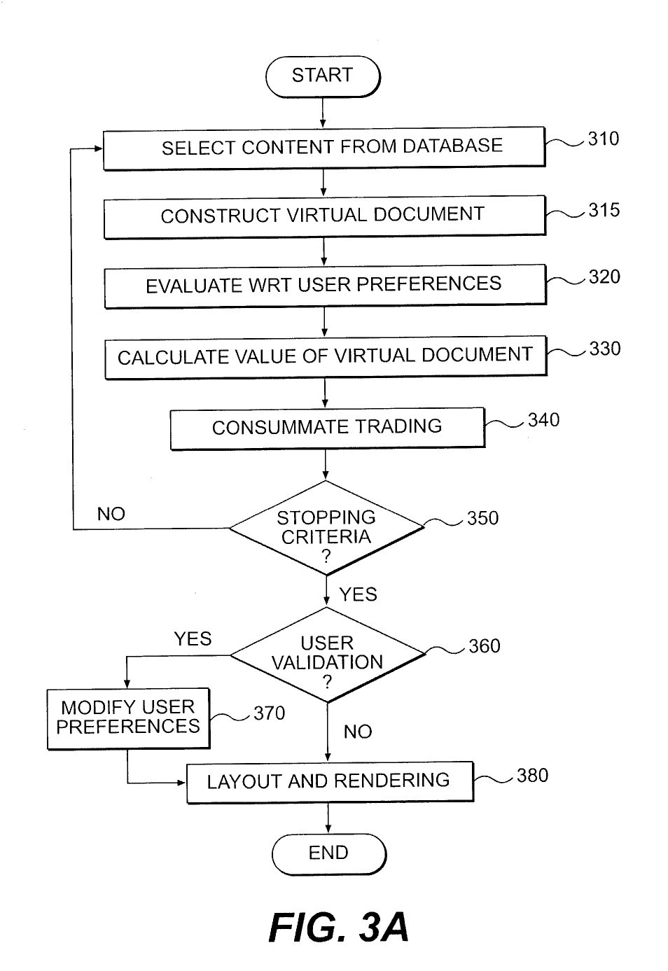

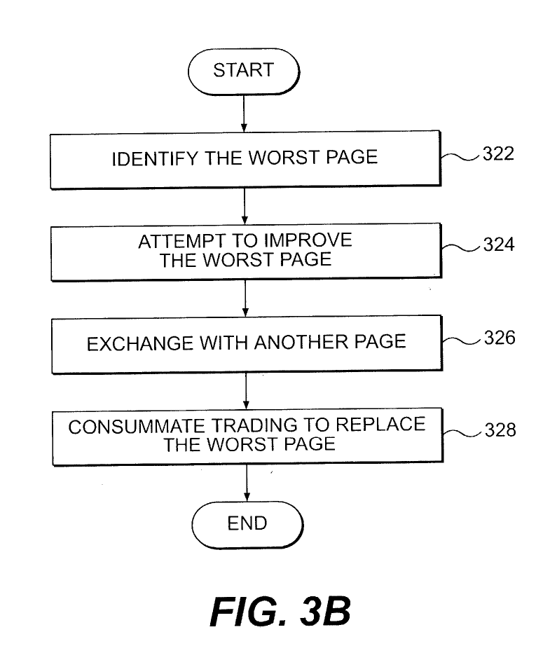

FIG. 2 illustrates an exemplary automated content selection system 210 that utilizes a market-based trading system 270 to automatically select content for document presentation through, for example, an auction process. The market-based trading system 270 uses a content selection algorithm (described in detail with respect to FIG. 3) and may include a content broker 250 for supervising and coordinating the type of content to be placed on various pages of a document. The automated content selection system 210 may have inputs from system configuration 201 and user preferences 202. The system configuration input 201 serves to set configuration parameters for the running of the content selection algorithm. The user preference input 202 serves to set the user preferences for actual content selection. Table 1 illustrates exemplary parameters of the system configuration input 201. Table 2 illustrates exemplary data structures of user preference input 202.

TABLE 1

| | System configuration | | |
|---|---|---|---|
| Port | Msg | | |
| Operations | Type | Msg Data | Msg Data Type |
| get_configuration_requirements | Input | configuration_type | string |
| | Output | attribute_value_pairs | attribute_value_pairs |
| get_all_configurations | Input | administrator_profile | administrator_profile |
| | Output | configuration_descriptions | configuration_descriptions |
| get_a_configuration | Input | configuration_id | string |
| | Output | configuration_description | configuration_description |
| new_configuration | Input | attribute_value_pairs | attribute_value_pairs |
| | | configuration_type | string |
| | Output | configuration_id | string |
| modify_configuration | Input | configuration_id | string |
| | | attribute_value_pairs | attribute_value_pairs |
| | Output | configuration_id | string |
| set_configuration | Input | authorization | string |
| | | attribute_value_pairs | attribute_value_pairs |
| | Output | configuration_id | ascii_file |

TABLE 2

| | User profile | | |
|---|---|---|---|
| Port | Msg | | |
| Operations | Type | Msg Data | Msg Data Type |
| get_profile_{—} | Input | profile_type | string |
| requirements | Output | attribute_value_pairs | attribute_value_pairs |
| get_all_{—} | Input | user_profile | user_profile |
| profiles | Output | profile_descriptions | profile_descriptions |
| get_a_profile | Input | profile_id | string |
| | Output | profile_description | profile_description |
| new_profile | Input | attribute_value_pairs | attribute_value_pairs |
| | | profile_type | string |
| | Output | profile_id | string |
| modify_profile | Input | profile_id | string |
| | | attribute_value_pairs | attribute_value_pairs |
| | Output | profile_id | string |
| set_profile | Input | authorization | string |
| | | attribute_value_pairs | attribute_value_pairs |
| | Output | profile_id | string |

With respect to user preferences 202, the automated content selection system 210 may accommodate any instruction received from the user. For example, the user preferences 202 may include an explicit user selection of specific contents with high appeal 220 or a user profile 230 that is connected to a customer resource management (CRM) system 240. One skilled in the art will appreciate that the CRM system 240 may be a knowledge management system, document management system, database management system, or other types of files management systems. The user profile 230 is typically compared to the CRM system 240 to select contents from a content collection database 245. Next, the content broker 250 may construct virtual documents based on the selected contents. With the CRM system 240, the contents preferred by similar customers, typically saved in the content collection database 245, may be used to construct the virtual documents. The virtual documents may then be scored by the content broker 250 based on the documents' value with respect to the user preferences 202. For example, a user may prefer images to be blue. Images in virtual documents may be graded on how much blue the images contain. The better the system 210 matches the characteristics specified by the user, the higher the value of the virtual document is with respect to the user preferences 202. A user may also select particular types of fonts or particular article sizes as preferences. Thereafter, the content broker 250 may consummate one or more trades to improve the virtual documents' value. After a number of trades the content broker 250 may select the best document with preferred contents, which is then sent to a composing program 260 for display or printing.

FIG. 3A is a flow chart illustrating an exemplary operation of the content broker 250. As noted above, the content broker 250 supervises and coordinates content selection. First, the content broker 250 selects a content from a database that includes collections or other documents (block 310) and constructs a virtual document using the newly selected content (block 315). Next, the content broker 250 evaluates the newly selected content (block 320) and calculates a value of the virtual document with respect to the user preferences 202 (block 330). The value of the virtual document may be calculated by comparing the attributes of the content (such as size, predominant color, latest version, or author's name) with the preferences defined by the user. The comparison may be explicit comparisons or other types of comparisons. If the value of the virtual document is increased with respect to the user preferences 202, the content broker 250 consummates a trade to exchange an old content with the newly selected content (block 340). The process of “select, construct, evaluate, calculate, and trade” is repeated until a stopping criterion is met (block 350). The stopping criterion may be met when the content “perfectly” matches the user preferences 202, the automated content selection system 210 cannot further improve the value of virtual documents, or a previously set number of cycles have been completed. Once the stopping criteria have been met (block 350), the user may choose to validate the results (block 360), and modify preferences (block 370) for future trading. The user validation phase need not be automated, but may involve viewing the printed document and adding updated preferences. Alternatively, the user may modify preferences (block 370) through a graphical user interface (GUI) while the content broker 250 continues with another round of trading. Finally, the virtual document with the highest value is selected to be sent for document layout and rendering (block 380).

FIG. 3B illustrates an exemplary evaluation process of block 320. An exemplary content selection algorithm may utilize an “Extremal Optimization” technique, which in general replaces extremely undesirable elements of a single sub-optimal solution with new, random elements. In the page layout selection context, the exemplary algorithm identifies the “worst” page (with respect to the user preferences 202) from the virtual documents (block 322) and attempts to improve the worst page (block 324). The improvements may be accomplished through exchanging content with another page or with the collection database 245 (block 326). The content broker 250 then consummates a trade between the worst page and another page if both pages are improved as a result of the trade (block 328). If the trade is made with the collection database 245, only the worst page needs to improve its value before a trade is consummated. The following are exemplary criteria demonstrating how contents are selected for inclusion on a page based on the value assigned to the various page content objects. Table 3 illustrates exemplary system configuration inputs.

TABLE 3

| Input Name | Description | Example |
|---|---|---|
| MaxCycles | Stopping | 4000 |
| | criteria = maximum | |
| | number of brokering | |
| | (trading) attempts | |
| | made before halting | |
| | to send output. | |
| MaxBooklets | Number of virtual | 4 |
| | booklets created by | |
| | the Content Broker | |
| | that can exchange | |
| | content among each | |
| | other | |
| CollectionPath | Location of cached | CollectionPath = |
| | content files | Artisan Commercial |
| | containing metadata. | Contemporary |
| | | Country |
| | | Traditional |
| | | Utilitarian |
| | | Victorian |
| SelectionBias | Parameter for biasing | 3.0 |
| | selection towards | |
| | trading with least | |
| | value components. | |
| | β = 0 => uniform, β > 0 | |
| | more biased toward | |
| | less valued content, | |
| | Bias(value) ∝ value^{-β} | |
| ProbTradeWithCollection | The probability that a | 0.5 |
| | trade will take place | |
| | with the collection | |
| | versus the other | |
| | virtual booklets. | |

Table 4 shows exemplary user preference inputs. Note that if StyleRank, Price parameters, and Date parameters are not specified (commented out), then the content will be based on similarity with respect to the “musthave” content. Thus StyleRank, Price, and Date may be explicitly selected by the user, or implicitly defined through the metadata of the “musthave” content.

TABLE 4

| Input Name | Description | Example |
|---|---|---|
| StyleRank | Relative numeric ranking | StyleRank\|artisan = 8\|commercial = 1\| |
| | of styles, or classes of | contemporary = 10\|country = 1\| |
| | material to be included | traditional = 1\|utilitarian = 2\|victorian = 2 |
| | in the final document | |
| PriceMin | Minimum price of the | 500 |
| | item | |
| PriceMax | Maximum price of the | 1000 |
| | item | |
| PriceBoundary | “loose” meaning that | strict |
| | prices outside the | |
| | boundaries are penalized | |
| | in a gradual fashion | |
| | rather than binary as | |
| | with “strict” setting. | |
| Maxpages | Number of pages in the | 6 |
| | final document | |
| StyleSimilarity | Bias toward content on a | high |
| Preference | page being similar | |
| LayoutDensity | Bias toward relative | low |
| | amount of content on a | |
| | page | |
| musthave | Content that must be | Big Flower by Logo Design\|Cube by Logo |
| | included in the document | Design\|Egg by Logo Design |
| mustnothave | Content that must not be | alante |
| | included in the document | |
| pdfpath | | path to pdf files |
| clustering | | multiclustering |
| contentrisk | Method for calculating | standarddeviation |
| | how risk is managed as a | |
| | function page value, one | |
| | of “standarddeviation”, | |
| | “kullbackleiblerentropy”, | |
| | “percentile”, “entropy” | |
| PreferenceWeight | | price = 10\|date = 0\|style = 5\|layout = 1\|density = 1 |

Table 5 shows one of the metadata outputs produced by the content broker 250 using a test case. The actual output by the content broker 250 is, for example, a file containing the names of the metadata files for the content selected by the content broker 250.

TABLE 5

| Input Name | Description | Example |
|---|---|---|
| collectionName | Name of the collection | homeproducts |
| uniqueId | A unique identifier within | 1178924251207260339 |
| | the database for this item | |
| roomId | Room code for which this | 11789 |
| | item is found | |
| SuperCatId | A “super” category | 24 |
| | identifier | |
| CatId | A category identifier | 25 |
| avId | | 12072 |
| prodId | Product id from the vendor | 60339 |
| Title | Title of the item | Zen Bath |
| MadeBy | Manufacturer | Lefroy Brooks |
| Price | Price of the item | 495.00 |
| Date | Date of manufacture | 2000 |
| Shown in | Color item is shown in, in | White |
| | the image | |
| Model | Model number | XO 7500 |
| Features | | Two-person design |
| Part of | Part of a broader collection | Zen collection |
| | of items by the same | |
| | designer | |
| Designer | | |
| Style | | Contemporary |
| MountType | | Pedestal |
| Material | | Acrylic |
| Color | | White |
| Finish | | |
| Dimensions | Physical dimensions of the | |
| | item | |
| Options | Any other specifications not | |
| | covered by the other | |
| | categories | |
| Domain | Where this item is found | Bathroom |
| Category | Category of the item | Bathroom appliances |
| ItemCategory | Sub-category of the item | Tubs |
| Picture | Name of the file where the | ZenBath.jpg |
| | image corresponding | |

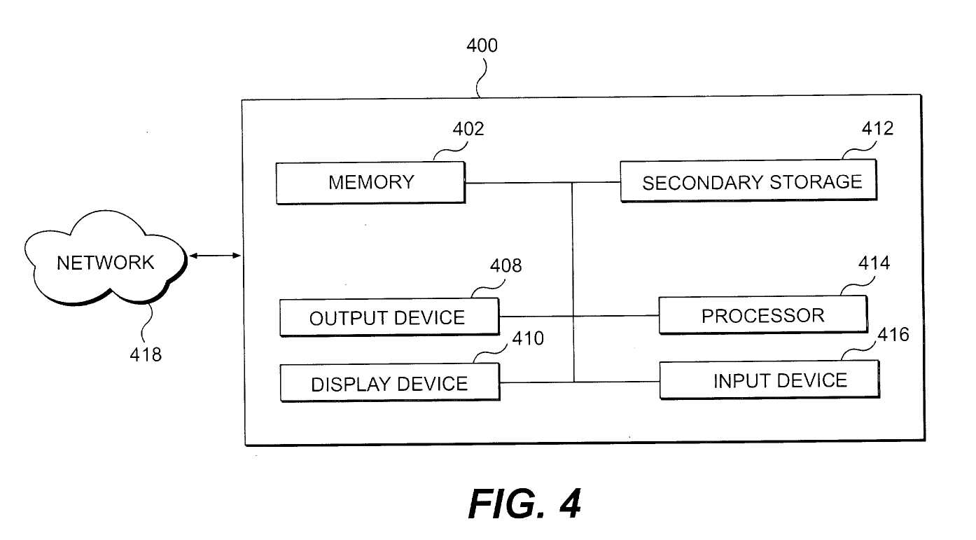

FIG. 4 illustrates exemplary hardware components of a computer 400 that may be used in connection with the method for market-based document content selection. The computer 400 includes a connection with a network 418 such as the Internet or other type of computer or telephone network. The computer 400 typically includes a memory 402, a secondary storage device 412, a processor 414, an input device 416, a display device 410, and an output device 408.

The memory 402 may include random access memory (RAM) or similar types of memory. The secondary storage device 412 may include a hard disk drive, floppy disk drive, CD-ROM drive, or other types of non-volatile data storage, and may correspond with various databases or other resources. The processor 414 may execute information stored in the memory 402, the secondary storage 412, or received from the Internet or other network 418. The input device 416 may include any device for entering data into the computer 400, such as a keyboard, keypad, cursor-control device, touch-screen (possibly with a stylus), or microphone. The display device 410 may include any type of device for presenting visual image, such as, for example, a computer monitor, flat-screen display, display panel or the like. The output device 408 may include any type of device for presenting data in hard copy format, such as a printer or printing device, and other types of output devices including speakers or any device for providing data in audio form. The computer 400 can possibly include multiple input devices, output devices, and display devices.

Although the computer 400 is depicted with various components, one skilled in the art will appreciate that the computer 400 can contain additional or different components. In addition, although aspects of an implementation consistent with the method for market-based document content selection are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling the computer 400 to perform a particular method.

While the method and apparatus for market-based document content selection have been described in connection with an exemplary embodiment, those skilled in the art will understand that many modifications in light of these teachings are possible, and this application is intended to cover any variations thereof.

What is claimed is:

1. A method for market-based document content selection, comprising:
selecting a plurality of contents from a database;
constructing a plurality of virtual documents using the plurality of selected contents;
evaluating the plurality of selected contents with respect to user preferences;
calculating values of the plurality of virtual documents based on the evaluation;
consummating a trade from an old content to one of the plurality of selected contents, if the value of the corresponding virtual document increases; and
generating a layout specification with preferred contents, after a stopping criterion is met, wherein the preferred contents are chosen from the plurality of selected contents for document rendering.

2. The method of claim 1, wherein the evaluating step includes evaluating the plurality of selected contents with respect to an explicit selection.

3. The method of claim 1, wherein the evaluating step includes evaluating the plurality of selected contents with respect to a user profile.

4. The method of claim 3, further comprising comparing the user profile to a customer resource management (CRM) system to construct the plurality of virtual documents.

5. The method of claim 4, wherein the CRM system includes a collection database.

6. The method of claim 1, further comprising validating the selection of the plurality of contents.

7. The method of claim 1, further comprising modifying the user preferences based on the preferred contents.

8. The method of claim 1, wherein the generating step includes generating the layout specification with the preferred contents, after one of the plurality of selected contents matches the user preferences.

9. The method of claim 1, wherein the generating step includes generating the layout specification with the preferred contents, after the values of the plurality of virtual documents cannot be improved.

10. The method of claim 1, wherein the generating step includes generating the layout specification with the preferred contents, after a set number of cycles are completed.

11. The method of claim 1, wherein the evaluating step comprises:
identifying a worst page with respect to the user preferences from the virtual documents; and
consummating a trade between the worst page and a second page if both pages are improved as a result of the trade.

12. An apparatus for market-based document content selection, comprising:
a system configuration input for setting configuration parameters for a content selection algorithm;
a user preference input for setting user preferences for the content selection algorithm; and
an automated content selection system capable of using the content selection algorithm to automatically select contents based on the user preferences, wherein the automated content selection system includes a content broker for supervising and coordinating the content selection.

13. The apparatus of claim 12, wherein the automated content selection system uses a market-based trading system for selecting the contents.

14. The apparatus of claim 12, wherein the user preference input includes an explicit selection of a set of contents.

15. The apparatus of claim 12, wherein the user preference input includes a selection based on a user profile.

16. A computer readable medium providing instructions for market-based document content selection, the instructions comprising:
selecting a plurality of contents from a database;
constructing a plurality of virtual documents using the plurality of selected contents;
evaluating the plurality of selected contents with respect to user preferences;
calculating values of the plurality of virtual documents based on the evaluation;
consummating a trade from an old content to one of the plurality of selected contents, if the value of the corresponding virtual document increases; and
generating a layout specification with preferred contents, after a stopping criterion is met, wherein the preferred contents are chosen from the plurality of selected contents for document rendering.

17. The computer readable medium of claim 16, wherein the instructions for evaluating include instructions for evaluating the plurality of selected contents with respect to an explicit selection.

18. The computer readable medium of claim 16, wherein the instructions for evaluating includes instructions for evaluating the plurality of selected contents with respect to a user profile.

19. The computer readable medium of claim 16, further comprising instructions for validating the selection of the plurality of contents.

20. The computer readable medium of claim 16, further comprising instructions for modifying the user preferences based on the preferred contents.

21. An apparatus for market-based document content selection, comprising:
means for selecting a plurality of contents from a database;
means for constructing a plurality of virtual documents using the plurality of selected contents;
means for evaluating the plurality of selected contents with respect to user preferences;
means for calculating values of the plurality of virtual documents based on the evaluation;
means for consummating a trade from an old content to one of the plurality of selected contents, if the value of the corresponding virtual document increases; and
means for generating a layout specification with preferred contents, after a stopping criterion is met, wherein the preferred contents are chosen from the plurality of selected contents for document rendering.

22. The apparatus of claim 21, further comprising means for modifying the user preferences based on the preferred contents.

23. The apparatus of claim 21, wherein the means for generating includes means for generating the layout specification with the preferred contents, after one of the plurality of selected contents matches the user preferences.

24. The apparatus of claim 21, wherein the means for generating includes means for generating the layout specification with the preferred contents, after the values of the plurality of virtual documents cannot be improved.

25. The apparatus of claim 21, wherein the means for generating includes means for generating the layout specification with the preferred contents, after a set number of cycles are completed.
